(19) United States
(12) Patent Application Publication
(10) Pub. No.: US 2026/0367009 A1
(43) Pub. Date: Nov. 19, 2026

(54) BIO SENSOR AND METHOD OF OPERATING THE SAME

(71) Applicant: SK hynix Inc., Icheon-si (KR)

(72) Inventor: Min Su CHO, Icheon-si (KR)

(21) Appl. No.: 19/386,076

(22) Filed: Nov. 11, 2025

(30) Foreign Application Priority Data
May 13, 2025 (KR) 10-2025-0061833

(51) Int. Cl. G01N 21/75

(52) U.S. Cl. CPC G01N 21/75

(57) ABSTRACT

A bio sensor is provided to include a meta lens configured to receive light from outside and spectrally split the light into different wavelength bands including first to third wavelength bands; and a plurality of pixel areas configured to receive the light that has reacted with the sample. The plurality of pixel areas comprises a first pixel area including a first photodetector receiving light of the first wavelength band; a third pixel area including a second photodetector receiving light of the third wavelength band; and a second pixel area including a third photodetector receiving light of the second wavelength band. Each of a difference between the first wavelength band and the second wavelength band and a difference between the second wavelength band and the third wavelength band is greater than a difference between the first wavelength band and the third wavelength band.

### PRIORITY CLAIM AND CROSS-REFERENCE TO RELATED APPLICATION

This patent document claims priority to and the benefit of Korean Patent Application No. 10-2025-0061833, filed on May 13, 2025, the disclosure of which is incorporated herein by reference in its entirety.

### TECHNICAL FIELD

The technology and implementations disclosed in this patent document generally relate to a bio sensor and a method of operating the same.

### BACKGROUND

With the development of the information and communication industry and the digitalization of electronic devices, image sensors with improved performance are being used in various fields such as digital cameras, camcorders, mobile phones, PCS (personal communication systems), game devices, security cameras, and medical micro cameras.

### SUMMARY

Various implementations of the disclosed technology provide a bio sensor that has low-cost, high-performance and portability, and a method of operating the bio sensor, including performing measurements of samples by hyperspectral imaging to obtain, at each pixel, images at different optical wavelengths of a sample or a scene.

Various technical effects can be achieved and inferred from following embodiments.

In one aspect, a bio sensor is provided to include a meta lens configured to receive light from outside and spectrally split the light into different wavelength bands including a first wavelength band, a second wavelength band, and a third wavelength band; and a plurality of pixel areas configured to receive the light that has reacted with the sample. The plurality of pixel areas comprises a first pixel area including a first photodetector configured to receive light of the first wavelength band; a third pixel area including a second photodetector configured to receive light of the third wavelength band; and a second pixel area disposed between the first pixel area and the third pixel area and including a third photodetector configured to receive light of the second wavelength band. Each of a difference between the first wavelength band and the second wavelength band, and a difference between the second wavelength band and the third wavelength band is greater than a difference between the first wavelength band and the third wavelength band.

In another aspect, a method of operating a bio sensor is provided to include using a meta lens spectrally split light received from an outside to light beams in different wavelength bands including a first wavelength band, a second wavelength band, and a third wavelength band; directing the light beams split by the meta lens to samples to be measured; and using a plurality of pixel areas to capture light from the samples under illumination of the light beams split by the meta lens. The plurality of pixel areas comprises: a first pixel area including a first photodetector configured to receive light of the first wavelength band; a third pixel area including a second photodetector configured to receive light of the third wavelength band; and a second pixel area disposed between the first pixel area and the third pixel area and including a third photodetector configured to receive light of the second wavelength band. Each of a difference between the first wavelength band and the second wavelength band, and a difference between the second wavelength band and the third wavelength band is greater than a difference between the first wavelength band and the third wavelength band.

In another aspect, a method of operating a bio sensor is provided to include disposing samples over photodetectors arranged in each of a plurality of pixel areas, each of the photodetectors configured to generate a pixel signal in response to light incident on the plurality of pixel areas; irradiating light to a meta lens disposed over the samples and configured to spectrally split light incident on the meta lens; changing a light path of the light spectrally split through the meta lens; and generating a wavelength-specific spectrum based on pixel signals output from the each of the photodetectors.

According to the embodiments, the light received through the meta lens is spectrally split into hyperspectral light of various wavelengths, and the spectrum for each wavelength may be generated through the pixel signal of the photodetector extracted through the optical reaction between the spectroscopic light and the sample. As a result, a low-cost, high-performance, and compact biosensor may be provided.

According to the embodiments, by changing the light path of hyperspectral light of various wavelengths spectrally split through the meta lens via the light guide plate, and by having the multiple pixel areas receive different wavelengths along the row direction and receive the same wavelength along the column direction, symptoms or properties of different samples may be detected for each row.

However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

FIG. 1 is a perspective view of an example of a bio sensor based on some implementations of the disclosed technology.

FIG. 2 is a plan view showing pixel areas based on some implementations of the disclosed technology.

FIG. 3 is a cross-sectional view cut away along A-A’ of FIG. 1.

FIG. 4 is a plan view showing examples of a sample passage, grid, and sample of a biosensor based on some implementations of the disclosed technology.

FIG. 5 is a cross-sectional view of an example of a bio sensor based on some implementations of the disclosed technology.

FIG. 6 is an example of a flow chart illustrating a method of operating a bio sensor based on some implementations of the disclosed technology.

FIG. 7 is an example of a flow chart illustrating a method of operating a bio sensor based on some implementations of the disclosed technology.

FIG. 8 is an example of a flow chart illustrating a method of operating a bio sensor based on some implementations of the disclosed technology.

FIG. 9 is an example of a schematic cross-sectional view of a bio sensor based on some implementations of the disclosed technology.

FIG. 10 is an example of a flow chart illustrating a method of operating a bio sensor based on some implementations of the disclosed technology.

FIG. 11 is an example of a cross-sectional view of a bio sensor based on some implementations of the disclosed technology.

FIG. 12 is an example of a plan view showing pixel areas of the bio sensor shown in FIG. 11.

FIG. 13 is an example of a flow chart illustrating a method of operating a bio sensor based on some implementations of the disclosed technology.

FIG. 14 is an example of a cross-sectional view of a bio sensor based on some implementations of the disclosed technology.

### DETAILED DESCRIPTION

Description will now be given in detail according to exemplary embodiments disclosed herein, with reference to the accompanying drawings.

For the sake of brief description with reference to the drawings, the same or equivalent components may be provided with the same reference numbers, and description thereof will not be repeated. "And/or" includes any combination of one or more of the associated configurations that can be defined.

These terms are generally only used to distinguish one element from another. It will be understood that the terms “first” and “second” are used herein to describe various components but these components should not be limited by these terms. The above terms are used only to distinguish one component from another. For example, a first component may be referred to as a second component and vice versa without departing from the scope of the invention. The singular expressions include plural expressions unless the context clearly dictates otherwise.

The terms such as "below," "underneath," "above," and "on" are used to describe the relationships between the components shown in the drawings. The terms are relative concepts and are described based on the directions shown in the drawings.

Terms such as “include” or “has” are used herein and should be understood that they are intended to indicate an existence of several components, functions or steps, disclosed in the specification, and it is also understood that greater or fewer components, functions, or steps may likewise be utilized.

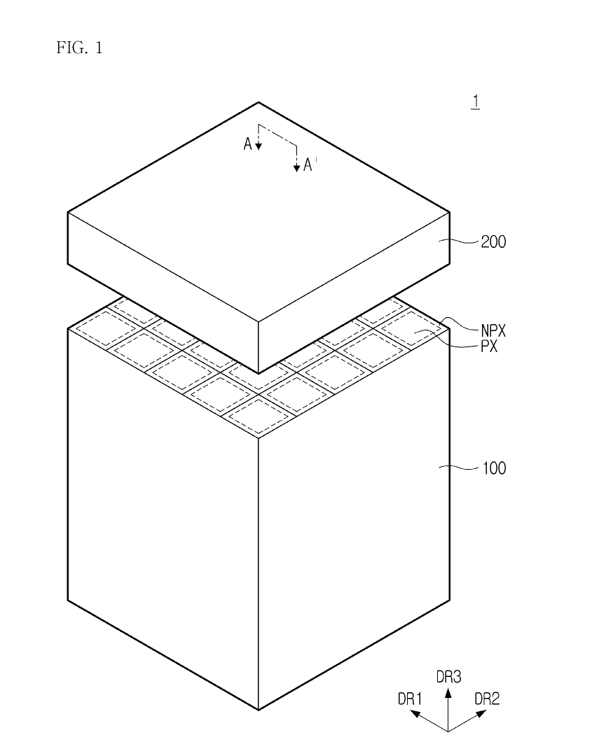

FIG. 1 is an example of a perspective view of a bio sensor based on some implementations of the disclosed technology.

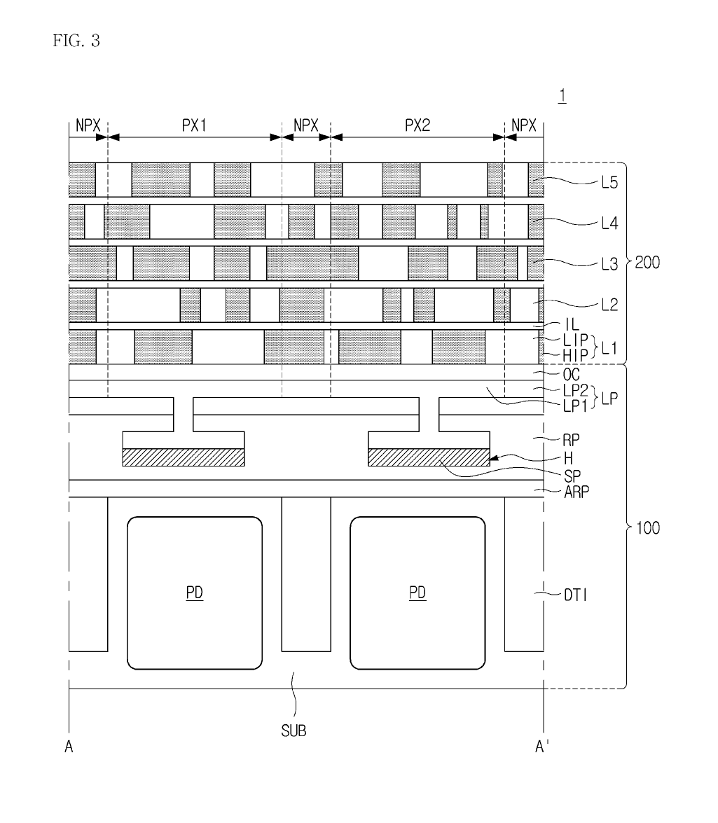

Referring to FIG. 1, the biosensor 1 according to one embodiment may include a meta lens 200 that directs probe light (e.g., hyperspectral probe light beams) to a sample to be measured, and an image sensing device 100 that captures images of the sample under illumination of the probe light. In some embodiments, e.g., the embodiment in FIG. 3, the image sensing device 100 may include a sample storage unit RP for holding the sample to be measured at a location in the light path between the meta lens 200 and the image sensing pixels of the image sensing device 100The meta lens 200 is disposed on the image sensing device 100. The image sensing device 100 may include pixel areas PX arranged in a plurality of matrix directions including rows and columns, and non-pixel areas NPX arranged between or around the pixel areas PX. A photodetector, which will be described later, may be arranged in the pixel areas PX. The non-pixel area NPX is a region without a photodetector and thus does not detect incident light. In the example in FIG. 1, the non-pixel area NPX is located between two adjacent pixels and is structured to reflect light from the respective adjacent pixels back to the adjacent pixels to increase the reception at each photodetector in the pixel areas. The non-pixel areas NPX may improve the overall optical detection efficiency, and reduce undesired optical crosstalks between adjacent pixels that would otherwise adversely reduce the image resolution and quality. The first direction DR1 illustrated in FIG. 1 may be, for example, a row direction of the pixel areas PX, and the second direction DR2 may be, for example, a column direction of the pixel areas PX but in this disclosure, the directions should be understood to be relative. The image sensing device 100 may be a CIS (Complementary Metal Oxide Semiconductor Image Sensor) that converts an optical signal into an electrical signal.

The meta lens 200 may be arranged to overlap with the image sensing device 100. In FIG. 1, the area of the meta lens 200 and the area of the image sensing device 100 are exemplified as being the same, but the embodiments are not limited thereto. In some implementations, the area of the meta lens 200 may be larger than the area of the image sensing device 100, or the area of the meta lens 200 may be smaller than the area of the image sensing device 100.

The meta lens 200 may be designed to spectrally split light incident from outside into light of different wavelengths within at least one wavelength range. In one embodiment, the meta lens 200 may split light incident from the outside into light of multiple wavelength ranges within the spectrum of the incident light. For example, the meta lens 200 may function to split light into wavelengths of a hyper spectrum. In some implementations, the wavelength range of the hyper spectrum may be, for example, a sufficiently wide spectral range such as the entire visible light wavelength range which may be from about 380 nm to about 780 nm. In the example, the plurality of pixel areas PX may receive light in different wavelengths such as at least four different wavelengths. Thus, the meta lens 200 may split the received light into at least four different wavelengths and output the split light with spectral light components within the at least four different wavelengths to each pixel area PX.

In some implementations, the meta lens 200 may collect light incident from the outside and output it to the pixel areas PX of the image sensing device 100 below.

The meta lens 200 and the image sensing device 100 will be described in detail later.

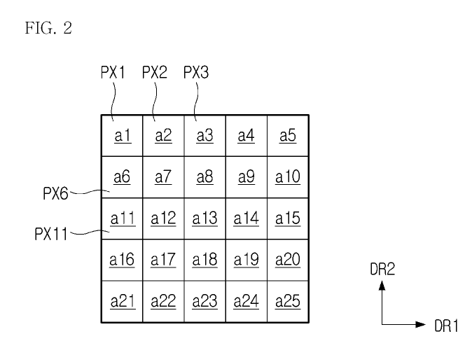

FIG. 2 is an example of a plan view showing pixel areas based on some implementations of the disclosed technology.

Referring to FIG. 2, pixel areas according to one embodiment can receive light of different wavelengths. In the example as shown in FIG. 2, pixel areas are divided according to whether they receive light of different wavelengths. For example, pixel areas may be arranged in an m*n manner (m is the number in the row direction, n is the number in the column direction, and m and n are each natural numbers greater than or equal to 2). In FIG. 2, an arrangement of pixel areas where m is 5 and n is 5 is exemplified. Thus, 25 pixel areas (PX1 to PX25) are exemplified. Each pixel area (PX1 to PX25) may receive light of different wavelengths.

Since the image sensing device according to one embodiment is used in a biosensor configured to detect symptoms or properties of a sample based on sensing by different pixel areas at different wavelengths, light mixing or optical crosstalks between adjacent pixel areas needs to be prevented. Therefore, in the example as shown in FIG. 2, for three adjacent pixels PX1, PX2, and PX3 disposed in the same row, the difference between the wavelength band received by the pixel area disposed in the center (e.g., the second pixel area PX2) and the wavelength bands received by the adjacent pixel areas (e.g., the first pixel area PX1 or the third pixel area PX3) may be greater than the difference between the wavelength bands received by the pixel areas separated by one pixel area (e.g., the first pixel region PX1 and the third pixel area PX3 that are spaced apart from each other by the second pixel area PX2). In FIG. 2, the wavelength bands received by each of the pixel areas PX1 to PX25 are expressed as a1 to a25. For example, the difference between the first wavelength band (a1) and the second wavelength band (a2) may be greater than the difference between the first wavelength band (a1) and the third wavelength band (a3), and the difference between the second wavelength band (a2) and the third wavelength band (a3) may be greater than the difference between the first wavelength band (a1) and the third wavelength band (a3).

The above description on the arrangement of pixel areas in the row direction may be applied to the arrangement of pixel arrays in the column direction as well. In the example, for three adjacent pixels PX1, PX6, PX11 in a common column, the difference between the wavelength band received by the pixel area arranged in the center (e.g., the sixth pixel area PX6) and the wavelength bands received by the adjacent pixel areas (e.g., the first pixel area PX1 or the eleventh pixel area PX11) may be greater than the difference between the wavelength bands received by the pixel areas separated by one pixel area (e.g., the first pixel area PX1 and the eleventh pixel area PX11 that are spaced apart from each other by the sixth pixel area PX6). However, the embodiments are not limited thereto, and the arrangement method described above may be applied in the row direction, and various methods (e.g., a method in which the wavelength band received linearly increases or decreases) may be applied in the column direction.

FIG. 3 is an example of a cross-sectional view cut away along A-A’ of FIG. 1. In FIG. 3, only the first pixel area PX1, the second pixel area PX2, and the non-pixel area PX3 are illustrated, but the cross-sectional structures of the other pixel areas described in FIG. 2 may also be the same.

Referring to FIG. 3, the image sensing device 100 may include a substrate SUB, a photodetector PD inside the substrate SUB, a separation unit DTI, an anti-reflection layer ARP, a sample storage unit RP on the anti-reflection layer ARP, a planarization layer OC, and a sample passage unit LP.

The substrate SUB may include silicon (Si) and have, for example, a first conductivity type (e.g., P-type). The photodetector PD is arranged in the substrate SUB and may have a second conductivity type (e.g., N-type). The photodetector PD may be arranged in each pixel area PX1 and PX2.

The separation unit DTI may be arranged in the non-pixel area NPX to prevent crosstalk between adjacent pixel areas. In some implementations, the separation unit DTI may partially penetrate the substrate SUB. In some other implementations, the separation unit DTI may completely penetrate the substrate SUB. The separation unit DTI may be formed in a Deep Trench Isolation manner. The separation unit DTI may include an insulating material and/or a conductive material. For example, examples of the insulating material may include at least one of hafnium oxide (HfOx), silicon oxide (SiOx), or tantalum oxide (TaOx), but the embodiments are not limited thereto. Examples of the conductive material may include polysilicon, but the embodiments are not limited thereto. For example, the separation unit DTI may have a structure in which a conductive material is sandwiched between insulating materials, but the embodiments are not limited thereto.

An anti-reflection layer ARP may be disposed on the upper surface of the substrate SUB. The anti-reflection layer ARP may include at least one insulating material, for example, hafnium oxide (HfOx), silicon oxide (SiOx), or tantalum oxide (TaOx), but the embodiments are not limited thereto. The anti-reflection layer ARP may serve to direct the light split through the meta lens 200 to the photodetector PD without reflecting it.

The sample storage unit RP may be disposed on the anti-reflection layer ARP to store a sample SP. A groove (H) is disposed in the sample storage unit RP. The groove (H) may recess the sample storage unit RP by forming a hollow in the sample storage unit RP. As shown in FIG. 3, the groove (H) may not completely recess the sample storage unit RP in the thickness direction, but may recess only to a certain depth in order to place the sample SP. The groove (H) may have a shape that is narrow at the upper portion of the sample storage unit RP but widens at the lower portion where the sample SP is actually placed, but the embodiments are not limited thereto. The sample storage unit RP may be formed of or include a rigid material to maintain the shape of the groove (H), but the embodiments are not limited thereto.

In one embodiment, the sample SP may include a certain sample (e.g., a specimen). In the description, the sample and the specimen are used interchangeably. For example, the sample or the specimen may refer to a material or organism used for a test, inspection, analysis, etc. with a specific purpose. For example, the sample or specimen may be a biological portion of substance or material, but the embodiments are not limited thereto.

In some embodiments, the sample SP may include a sample and a reagent mixed with the sample. For example, the reagent may be a chemical agent used in a reaction for detecting or quantifying a substance or organism in chemical analysis. For example, the reagent may react with light or the sample.

The planarization layer OC may be arranged on the sample storage unit RP. The planarization layer OC may include an organic material, but the embodiments are not limited thereto, and may include an inorganic material.

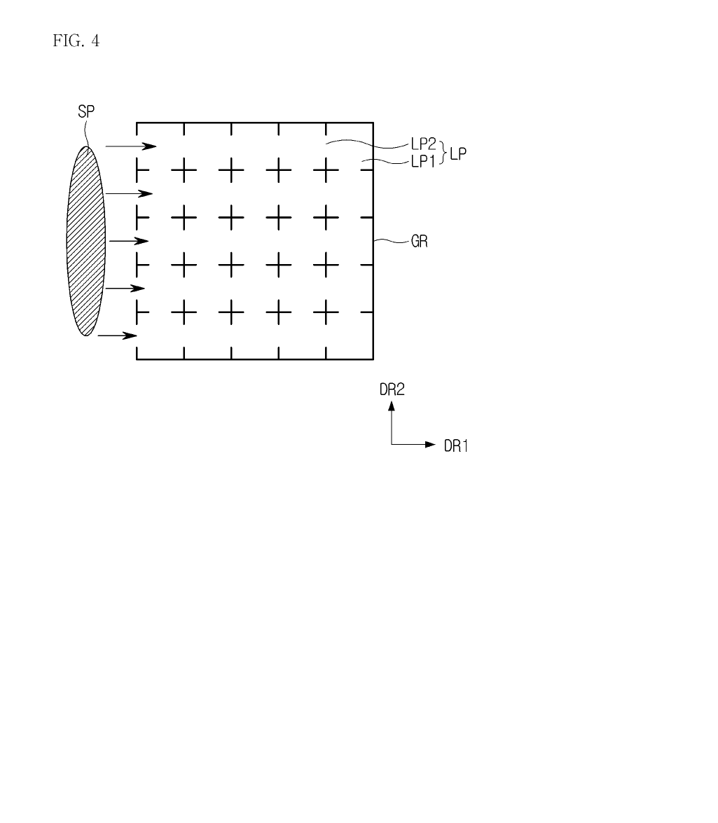

The sample passage unit LP may be arranged inside the planarization layer OC. The sample SP described above may be injected through the sample passage unit LP or may be arranged in the groove (H) of the sample storage unit RP. The sample passage unit LP may include a first sample passage portion LP1 arranged in the pixel area PX1 and PX2, and a second sample passage portion LP2 arranged in the non-pixel area NPX. The first sample passage portion LP1 arranged in each pixel area PX1 and PX2 is surrounded by a grid portion GR arranged in a portion of a non-pixel area (NPX) to be described later in FIG. 4, but is open at the second sample passage portion LP2 arranged in another portion of the non-pixel area NPX, so that the first sample passage portions LP1 of adjacent pixel areas PX1 and PX2 may be connected. The sample passage unit LP may be an empty space (or air), but the embodiments are not limited thereto. The first sample passage portion LP1 may be connected to the groove (H) described above by penetrating the planarization layer OC in a portion of the area (e.g., the central area). Therefore, the sample SP introduced into the sample passage unit LP may be moved to the groove (H).

The meta lens 200 may be arranged on the planarization layer OC to spectrally split the light received from outside. The meta lens 200 may include one or more meta structure layers L1, L2, L3, L4, and L5. Each meta structure layers refers to a layer of material with a surface patterned with nanostructures. The arrangement, alignment, or width of these nanostructures may vary between different meta-structure layers (L1-L5) to achieve the desired optical effect, such as splitting light into multiple, discrete wavelength bands. In FIG. 3, five sequentially stacked meta structure layers L1 to L5 are exemplified. The embodiments are not limited thereto. For example, the number of meta structure layers may be varied without being limited to 5. Thus, the number of meta structure layers may be 2 to 4, or 6 or more.

Each of the meta structure layers L1 to L5 may include at least one first portion HIP and at least one second portion LIP. The at least one first portion HIP and the at least one second portion LIP may be provided in multiples, but the embodiments are not limited thereto. The first portion HIP and the second portion LIP may be arranged alternately in the horizontal direction. The refractive index of the first portion HIP may be greater than the refractive index of the second portion LIP. In the example, the first portion HIP may be a high-refractive-index layer, and the second portion LIP may be a low-refractive-index layer. For example, the first portion (HIP) may include silicon nitride, tantalum oxide, or titanium oxide, and the second portion LIP may include silicon oxide or air, but the embodiments are not limited thereto. The size (width or height) of each of the first portion HIP and the second portion LIP may be from about 20 nm to about 150 nm, but the embodiments are not limited thereto.

The arrangement, alignment, or width of the first portion HIP and the second portion LIP of each meta-structure layer L1 to L5 may differ from one another. Through the design of the width, arrangement, or alignment of the first portion HIP and the second portion LIP of each meta-structure layer L1 to L5, the meta lens 200 can spectrally split the received light into light of hyperspectral wavelength ranges.

The meta lens 200 may further include an insulating layer IL arranged between adjacent meta-structure layers L1 to L5. The insulating layer IL may have a refractive index between the refractive index of the first portion HIP and the refractive index of the second portion LIP to reduce reflectivity in adjacent meta-structure layers L1 to L5, but the embodiments are not limited thereto.

FIG. 4 is an example of a plan view showing a sample passage unit, grid, and sample of a biosensor based on some implementations of the disclosed technology.

Referring to FIG. 4, as described above in FIG. 3, the grid portion GR may be arranged in a portion of the non-pixel area (NPX of FIG. 3). The grid portion GR may include a material that absorbs or reflects light to prevent light mixing or optical crosstalks between adjacent pixel areas (see PX1 and PX2 of FIG. 3). For example, the grid portion GR may include metal, e.g., tungsten (W), but the embodiments are not limited thereto. The first sample passage portion LP1 may be surrounded by the non-pixel area (see NPX of FIG. 3). The grid portion GR may be arranged in all non-pixel areas corresponding to the outer sides except the non-pixel area located in the direction in which the sample SP is injected. In the example of FIG. 4, the grid portion GR may be disposed on three outer sides of the pixel array but not be disposed on one outer side (e.g., the non-pixel area extending in the second direction DR2 and located on the left side as shown in FIG. 4). The grid portion GR may not be arranged in non-pixel areas located in the direction in which the sample SP is injected (e.g., the non-pixel area extending in the second direction DR2 and located on the left side as shown in FIG. 4). This configuration forms an opening for the injection of a sample (SP) from the left side, as shown in FIG. 4.

The second sample passage portion LP2 may be arranged in another area (e.g., the center) of the non-pixel area (see NPX of FIG. 3). The second sample passage portion LP2 may be arranged, for example, together with the grid portion GR in the non-pixel area (arranged for each pixel area) located in the direction in which the sample SP is initially injected, and may be arranged in another area of the non-pixel area located at the boundary between adjacent first sample passage portions LP1 to connect the adjacent first sample passage portions LP1. Thus, the second sample passage portion LP2 may connect the adjacent first sample passage portions LP1 by partially opening the grid portion GR within a plurality of pixel areas. Accordingly, the sample SP may be arranged in a groove (see H of FIG. 3) overlapping all pixel areas.

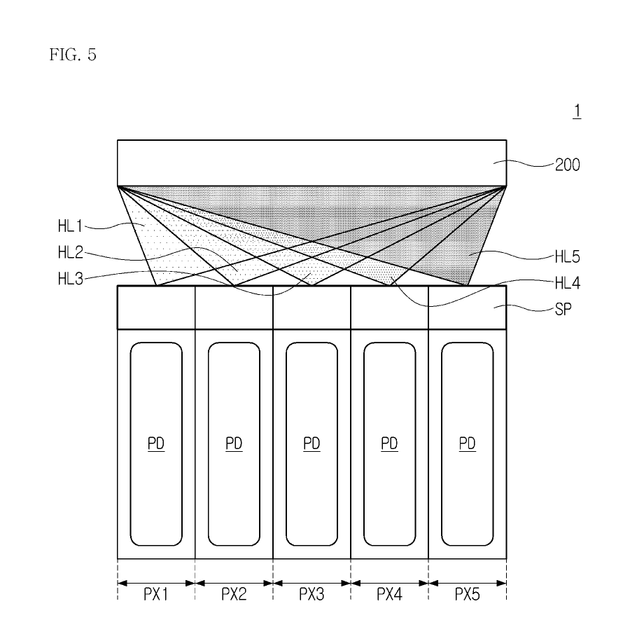

FIG. 5 is an example of a cross-sectional view of a bio sensor according to one embodiment.

Referring to FIG. 5, as described above in FIG. 3, the meta lens 200 may split the received light into hyperspectral lights HL1, HL2, HL3, HL4, and HL5 and output them to the corresponding pixel areas PX1, PX2, PX3, PX4, and PX5. The sample SP may be placed between the meta lens 200 and the photodetector PD of each pixel area PX1-PX5.

Hereinafter, a method of operating a biosensor according to one embodiment will be described. In describing the operating method, FIGS. 1-5, which have been previously described, may be referred to together.

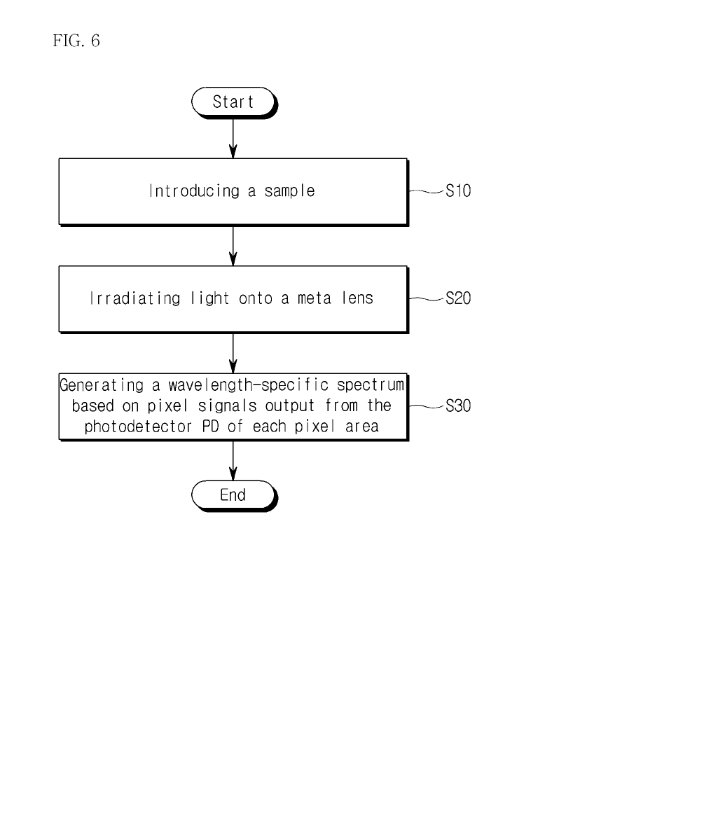

FIG. 6 is an example of a flow chart showing a method of operating a bio sensor based on some implementations of the disclosed technology.

Referring to FIGS. 3 and 6, the method of operating the bio sensor according to one embodiment may include a step S10 of introducing a sample SP. The sample SP may be a sample or a mixture of a sample and a reagent. In the description below, the sample SP is a sample.

In step S10, the sample may be placed in the groove (H) of the sample storage unit RP of each pixel area through the sample passage unit LP described in FIGS. 3 and 4.

Next, referring to FIGS. 3 and 6, the method of operating the bio sensor according to one embodiment may include a step S20 of irradiating light to a meta lens 200. The meta lens 200 may split the irradiated light into light of wavelengths of a hyper spectrum. As described above, the wavelength of the hyper spectrum may be, for example, the entire visible light wavelength range. The visible light full wavelength range can be from about 380 nm to about 780 nm, and the plurality of pixel areas PX according to one embodiment may receive at least four different wavelengths.

Next, referring to FIGS. 3 and 6, the method of operating the bio sensor according to one embodiment can include a step S30 of generating a wavelength-specific spectrum based on pixel signals output from the photodetectors PDs of each pixel area.

The light spectrally split by the meta lens 200 may travel to the corresponding pixel areas and photoreact with the sample SP on the photodetectors PDs of the corresponding pixel areas. When the sample SP is a sample, the spectrally split light that photoreacts with the sample may have a change in wavelength unlike the spectrally split light (spectroscopic light) that does not photoreact with the sample. In some implementations, the spectrally split light that photoreacts with the sample may be received by the photodetectors PDs of each pixel area. The photodetectors PDs of each pixel area output a pixel signal, and the image signal processor ISP of the image sensing device may generate a spectrum for each wavelength based on the pixel signals output from each photodetector PD, and may detect (or determine) the symptom of the sample based on the generated spectrum for each wavelength. For example, in the process of detecting the sample, the symptom of the sample may be detected by extracting a response curve for the wavelength in the form of spectroscopy, or by extracting an image for the incident wavelength, but the embodiments are not limited thereto.

Hereinafter, a method of operating a bio sensor according to another embodiment will be described.

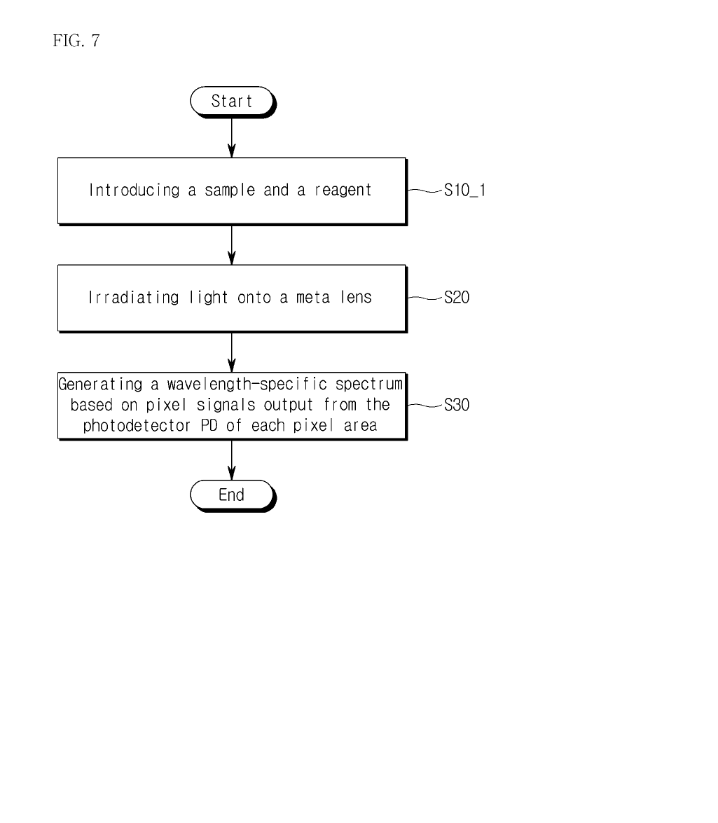

FIG. 7 is an example of a flow chart showing a method of operating a bio sensor based on some implementations of the disclosed technology.

Referring to FIGS. 3 and 7, the method of operating the bio sensor according to the present embodiment is different from the method shown in FIG. 6 in that the sample SP includes a sample and a reagent, and the sample and the reagent are simultaneously injected at S10_1.

According to the present embodiment, the sample and the reagent may be injected simultaneously. The sample and the reagent may be injected through the sample passage unit LP and placed in the groove H of the sample storage unit RP of each pixel area.

In the present embodiment, the reagent may react with the sample or the spectroscopic light, and may play a role in clearly changing the wavelength of the spectroscopic light produced by the sample. The use of the reagent is not limited to what has been described, and may also be applied to various uses including those uses widely known in the art.

The descriptions, which have been already provided in relation to FIG. 6, can be applied to FIG. 7 as well and are omitted here.

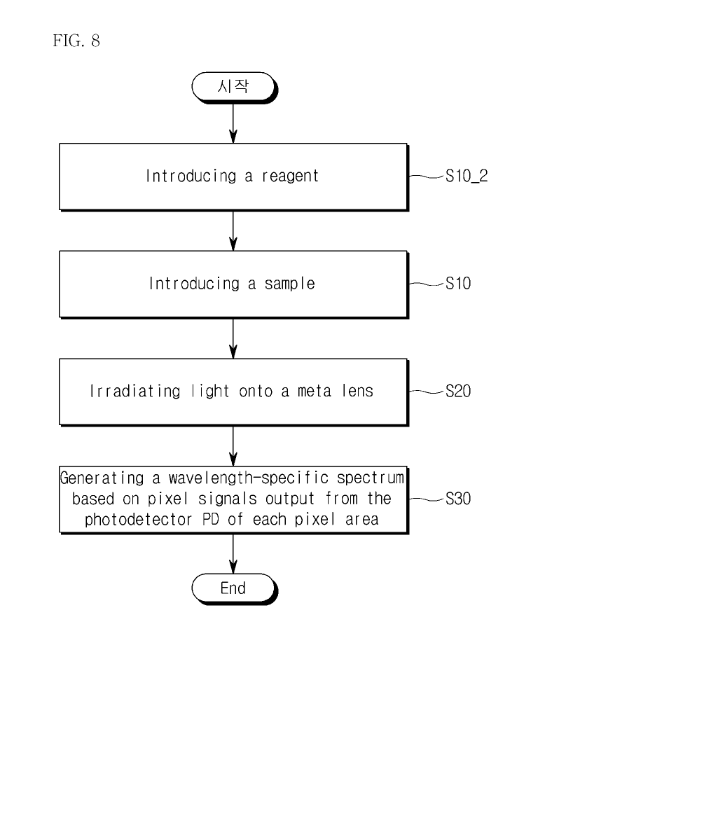

FIG. 8 is an example of a flow chart showing a method of operating a bio sensor based on some implementations of the disclosed technology.

Referring to FIGS. 3 and 8, the method of operating the bio sensor according to the present embodiment is different from the method shown in FIG. 7 in that the sample SP includes a sample and a reagent, and the sample and the reagent are simultaneously injected S10_b.

According to the present embodiment, the step of injecting the reagent S10 may be performed after the step of injecting the reagent S10_2.

According to the present embodiment, when the reagent and the sample are simultaneously injected into each groove (H), there is an advantage in that the reaction between the sample and the reagent can be minimized before the light is irradiated.

In the present embodiment, the reagent may react with the sample or the spectroscopic light, and may play a role in clearly changing the change in the wavelength of the spectroscopic light by the sample. The use of the reagent is not limited to what has been described, and may be applied to other uses widely known in the art.

The descriptions, which have been already provided in relation to FIG. 7, can be applied to FIG. 8 as well and are omitted here.

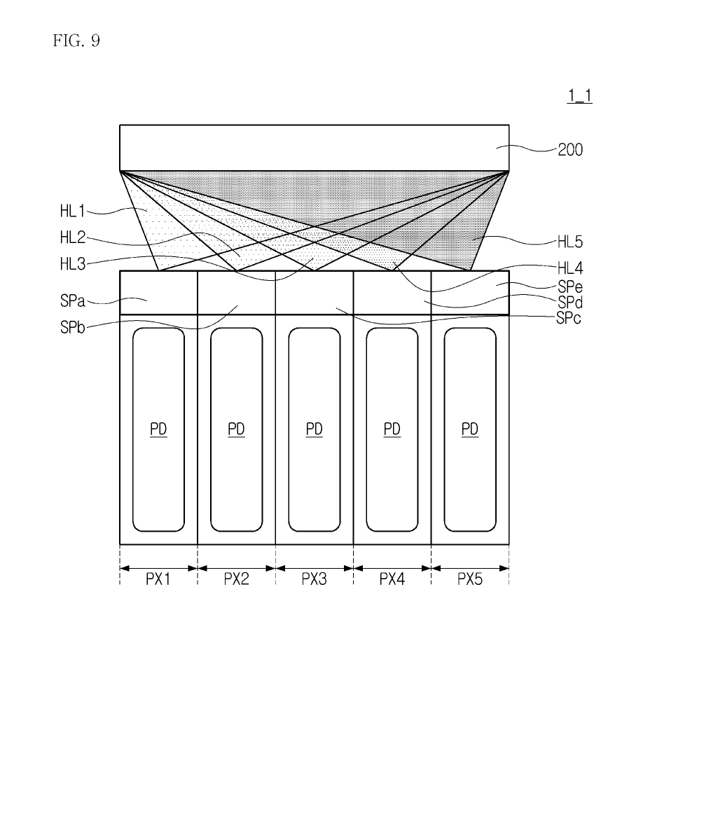

FIG. 9 is an example of a schematic cross-sectional view of a bio sensor based on some implementations of the disclosed technology.

Referring to FIG. 9, the meta lens 200 of the bio sensor 1_1 according to the present embodiment may split the received light into hyperspectral lights HL1, HL2, HL3, HL4, and HL5 and output them to corresponding pixel areas PX1, PXb, PX3, PX4, and PX5. Different samples SPa, SPb, SPc, SPd, and SPe may be placed in each pixel area PX1, PX2, PX3, PX4, and PX5. The sample may be a mixture of a sample and a reagent, and each of the samples SPa, SPb, SPc, SPd, and SPe may contain the same sample but different reagents.

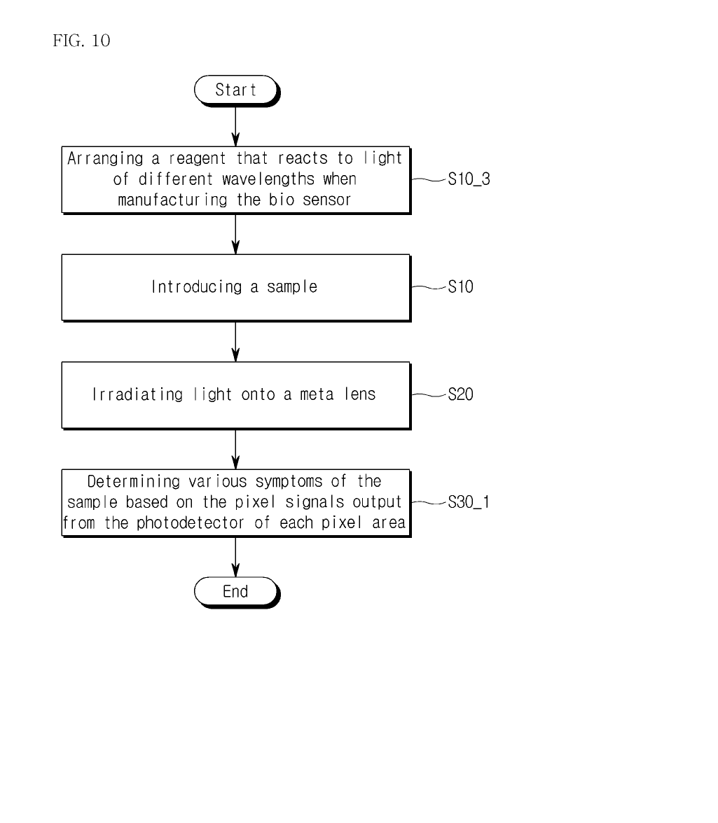

FIG. 10 is an example of a flow chart showing a method of operating a bio sensor based on some implementations of the disclosed technology.

Referring to FIGS. 3 and 10, the method of operating the bio sensor according to the present embodiment may include a step S10_3 of arranging reagents that react to light of different wavelengths when manufacturing the bio sensor (or when manufacturing the image sensing device).

The reagents may be placed in the groove (H) when manufacturing the image sensing device. The reagents placed in each pixel area may be different. Since the reagents are different, when the reagents are injected through the sample passage unit LP of FIG. 3, the reagents are mixed, so as described above, when manufacturing the image sensing device, they may be first placed in the groove H.

However, the samples placed in each pixel area may be the same.

Next, the method of operating the biosensor according to the present embodiment may include a step S10 of introducing a sample. The detailed description of step S10 will be omitted as described above.

Next, the method of operating the biosensor according to the present embodiment may include a step S20 of irradiating light to the meta lens 200. The detailed description of step S20 will be omitted as described above.

Next, the method of operating the bio sensor according to the present embodiment may include a step S30_1 of determining various symptoms or properties of the sample based on the pixel signals output from the photodetector of each pixel area. Unlike step S30 of FIG. 6, the step S30_1 may determine various symptoms or properties of the sample since various reagents are placed in each pixel area. In this step S30_1, unlike the step S30 of FIG. 6, a step of generating a spectrum by wavelength may not be performed. When the spectroscopic light is irradiated to the sample, the spectroscopic light reacts with different reagents of each pixel area, and the different light-reacting reagents chemically react with the sample, thereby detecting (or determining) various symptoms or properties of the sample.

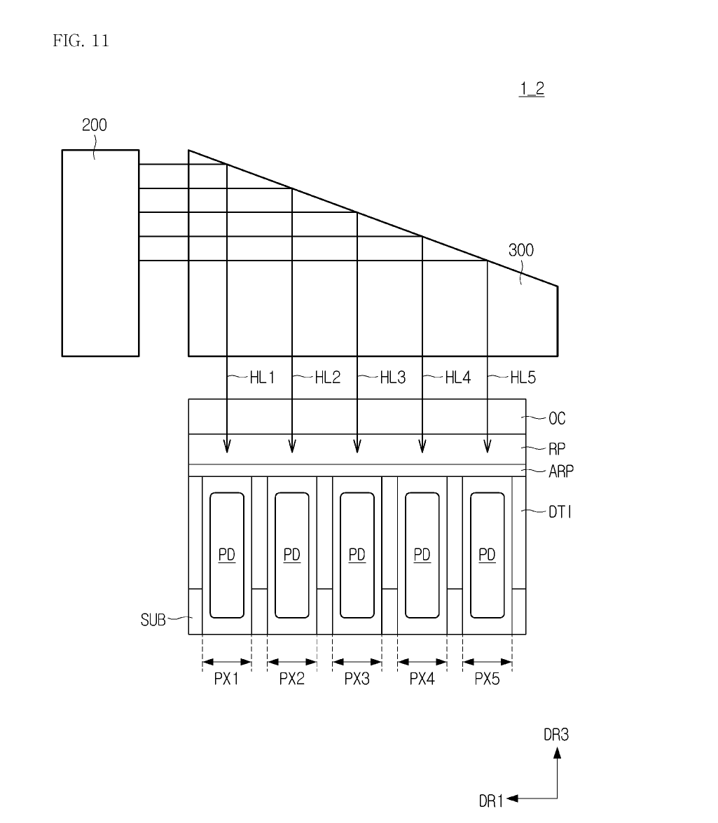

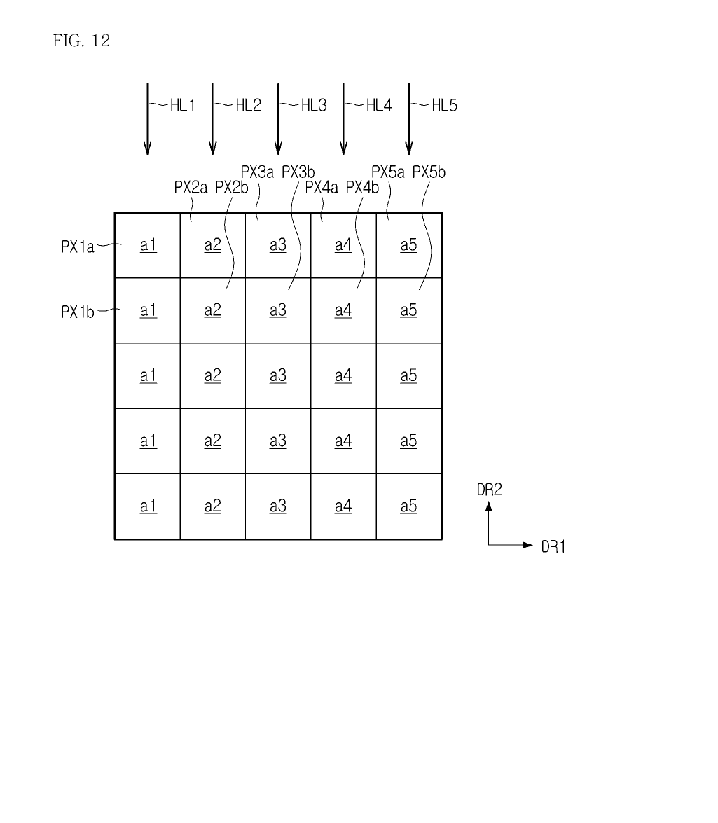

FIG. 11 is an example of a cross-sectional view of a bio sensor based on some implementations of the disclosed technology. FIG. 12 is an example of a plan view showing pixel areas of the bio sensor shown in FIG. 11.

Referring to FIGS. 11 and 12, the bio sensor 1_2 according to the present embodiment is different from the bio sensor 1 shown in FIG. 3 in that it further includes a light guide plate 300.

In some implementations, the light guide plate 300 may change the light path of the light spectrally split by the meta lens 200. As illustrated in FIG. 11, for example, the light split by the meta lens 200 may travel in the first direction DR1, be reflected from the upper surface of the light guide plate 300, and change the path to the third direction DR3 (or downward direction). To this end, the upper surface of the light guide plate 300 may extend in a diagonal direction between the first direction DR1 and the third direction DR3, as illustrated in FIG. 11. In addition, in order to totally reflect light on the upper surface of the light guide plate 300, the light guide plate 300 may include a high refractive material. For example, the light guide plate 300 may include silicon nitride, titanium oxide, tantalum oxide, aluminum oxide, or hafnium oxide, but the embodiments are not limited thereto.

The light beams HL1, HL2, HL3, HL4, and HL5 that are split may be output to the corresponding pixel areas PX1, PX2, PX3, PX4, and PXb, respectively.

As illustrated in FIG. 12, the light beams HL1, HL2, HL3, HL4, and HL5 that are changed in the light path through the light guide plate 300 may each proceed to the pixel areas arranged in the column direction. That is, the pixel areas arranged in the same pixel column may receive the light beams HL1, HL2, HL3, HL4, and HL5 of the same wavelength. For example, a first light HL1 having a first wavelength band a1 may travel to first sub-pixel areas PX1a, PX1b, etc., a second light HL2 having a second wavelength band a2 may travel to second sub-pixel areas PX2a, PX2b, etc., a third light HL3 having a third wavelength band a3 may travel to third sub-pixel areas PX3a, PX3b, etc., a fourth light HL4 having a fourth wavelength band a4 may travel to fourth sub-pixel areas PX4a, PX4b, etc., and a fifth light HL5 having a fifth wavelength band a5 may travel to fifth sub-pixel areas PX5a, PX5b, etc..

Furthermore, the same sample may be placed in sub-pixel areas (e.g., PX1a, PX2a, PX3a, PX4a, and PX5a) arranged in the same pixel row, but different samples may be placed in sub-pixel areas (e.g., PX1a and PX1b) arranged in different pixel rows. The sample in the present embodiment may be a sample or a mixture of a sample and a reagent.

Therefore, the symptoms or properties of a sample detected by the wavelength-specific spectrum generated based on the pixel signals generated from the photodetectors PDs of the sub-pixel areas arranged in the same pixel row may be the same, but they may be different from the symptoms or properties of a sample detected by the wavelength-specific spectrum generated based on the pixel signals generated from the photodetectors PDs of the sub-pixel areas arranged in different pixel rows. For example, the first symptom of a sample can be detected by the wavelength-specific spectrum generated from the sub-pixel areas (e.g., PX1a, PX2a, PX3a, PX4a, and PX5a) arranged in the first pixel row, and the second symptom of a sample can be detected by the wavelength-specific spectrum generated from the sub-pixel areas (e.g., PX1b, PX2b, PX3b, PX4b, PX5b) arranged in the second pixel row.

Therefore, since the bio sensor 1_2 additionally includes the light guide plate 300, there is an advantage in that various symptoms or properties of a sample may be detected.

In some embodiments, the light guide plate 300 may be divided into multiple parts. For example, the light guide plate 300 may include multiple sub light guide plates. The sub light guide plates may receive light spectrally split by the meta lens 200. For example, the sub light guide plates may include a first sub light guide plate, a second sub light guide plate, a third sub light guide plate, a fourth sub light guide plate, and a fifth sub light guide plate. The first sub-light guide plate may direct the first light HL1 to the first sub-pixel area (PX1a, PX1b, etc.), the second sub-light guide plate may direct the second light HL2 to the second sub-pixel area (PX2a, PX2b, etc.), the third sub-light guide plate may direct the third light HL3 to the third sub-pixel area (PX3a, PX3b, etc.), the fourth sub-light guide plate may direct the fourth light HL4 to the fourth sub-pixel area (PX4a, PX4b, etc.), and the fifth sub-light guide plate may direct the fifth light HL5 to the fifth sub-pixel area (PX5a, PX5b, etc.). Each of the sub-light guide plates may be arranged to be spaced apart from each other in the first direction DR1, but the embodiments are not limited thereto.

Each sub-light guide plate can correspond to (or overlap) the pixel areas PX1, PX2, PX3, PX4, and PX5 below.

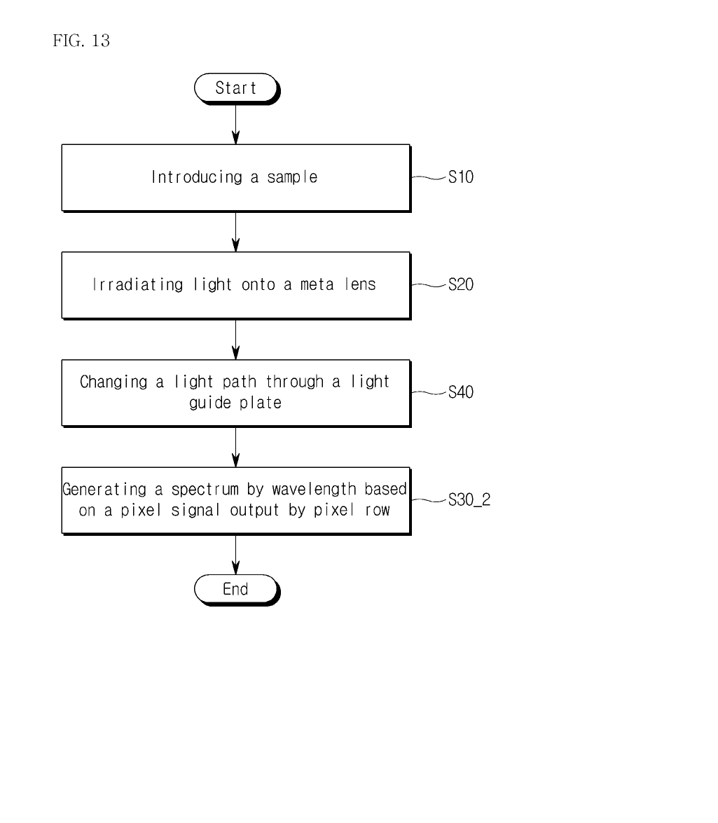

The refractive index of each sub-light guide plate may be greater than the refractive index of the region between adjacent sub-light guide plates (e.g., air, or a low-refractive insulating layer, etc.). Therefore, light mixing between adjacent sub-light guide plates may be minimized. The region between adjacent sub-light guide plates may include air, or a low-refractive material such as silicon oxide, but the embodiments are not limited thereto. FIG. 13 is a flowchart showing an operating method of a bio sensor according to another embodiment. Steps S10 and S20 of FIG. 13 are described in FIG. 6, and thus a description thereof will be omitted.

Referring to FIGS. 11 and 13, the method of operating the bio sensor according to the present embodiment may include a step S40 of changing the light path through the light guide plate 300 after a step S20 of irradiating light to the meta lens. A detailed description thereof will be omitted as it is described in FIG. 11.

The method of operating the bio sensor according to the present embodiment may include a step S30_2 of generating a spectrum by wavelength based on pixel signals output by pixel row after the step S40 of changing the light path through the light guide plate 300. A detailed description of the step S30_2 of generating a spectrum by wavelength based on pixel signals output by pixel row is omitted as it is described above with reference to FIG. 11.

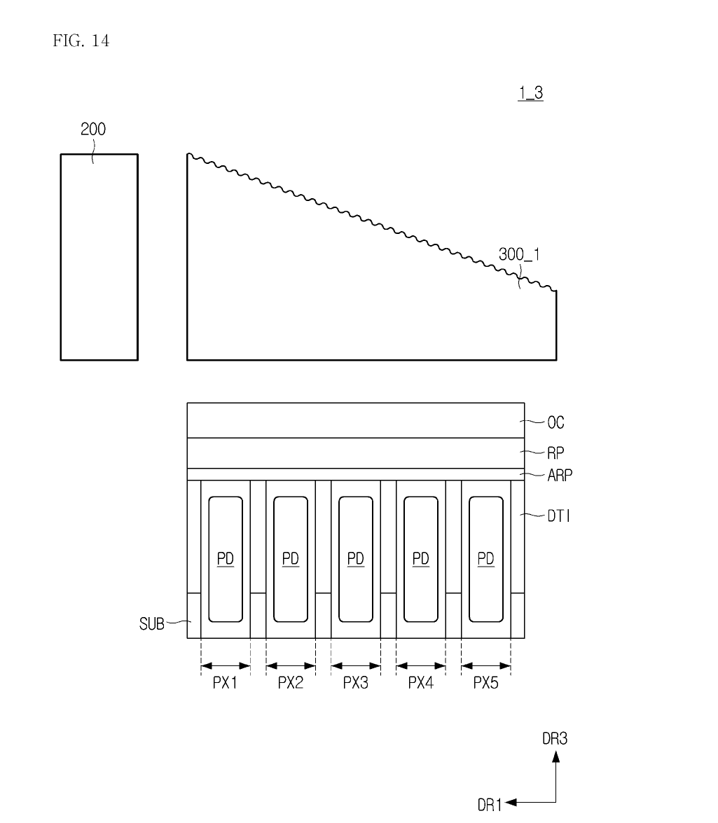

FIG. 14 is an example of a cross-sectional view of a bio sensor based on some implementations of the disclosed technology.

Referring to FIG. 14, the bio sensor 1_3 according to the present embodiment is different from the bio sensor 1_2 according to FIG. 11 in that a scattering pattern may be formed on the upper surface of the light guide plate 300_1.

In some implementations, the scattering pattern formed on the upper surface of the light guide plate 300_1 may uniformly propagate light toward the image sensing device 100. In some embodiments, the scattering pattern on the upper surface of the light guide plate 300_1 may have different sizes depending on the location, and may be distributed with different densities.

The description of other aspects is omitted as described above in FIG. 11.

The bio sensor according to various embodiments of the present specification may be described as follows.

According to the embodiments of the present disclosure, the bio sensor may include a meta lens configured to spectrally split received light into light of a first wavelength band, a second wavelength band, and a third wavelength band; a sample configured to react with the split light (spectroscopic light); and a plurality of photodetectors configured to receive the split light reacting with the sample and arranged in each of a plurality of pixel areas. The plurality of pixel areas may include a first pixel area into which light of the first wavelength band is incident; a third pixel area into which light of the third wavelength band is incident; and a second pixel area between the first pixel area and the third pixel area into which light of the second wavelength band is incident, and the difference between the first wavelength band and the second wavelength band, and the difference between the second wavelength band and the third wavelength band may be each greater than the difference between the first wavelength band and the third wavelength band.

The meta lens may spectrally split the received light with hyperspectral.

The bio sensor may further include a groove in which the sample is disposed on each of the pixel areas on the photodetectors; and a blocking portion configured to surround the groove. The groove may recess the blocking portion from an upper surface. The bio sensor may further include a planarizing layer on the blocking portion; and a sample passage unit penetrating the planarizing layer, and the sample passage unit may recess the planarizing layer in a first direction and recess the planarizing layer in a second direction intersecting the first direction to be connected to the groove.

The meta lens comprises a plurality of meta-structure layers, and each of the meta-structure layers including at least one first portion and at least one second portion having a lower refractive index than the at least one first portion, and in each of the meta-structure layers, the at least one first portion and the at least one second portion may be arranged alternately.

The first portion may include silicon nitride, tantalum oxide, or titanium oxide, and the second portion may include silicon oxide or air.

The meta lens may further include an insulating layer between adjacent meta-structure layers, and the refractive index of the insulating layer may have a value between the refractive index of the at least one first portion and the refractive index of the at least one second portion.

The sample may include a sample that photosensitizes with the split lights.

The sample may include a sample and a reagent that reacts with the sample, and the sample may react with the spectroscopic lights.

A sample on the first pixel area, a sample on the second pixel area, and a sample on the third pixel area may be all the same.

A sample on the first pixel area, a sample on the second pixel area, and a sample on the third pixel area may be all different.

The bio sensor may further include a light guide plate configured to change a light path of the spectroscopic light and make it incident into the sample.

A scattering pattern may be formed on an upper surface of the light guide plate.

The light guide plate may include sub light guide plates arranged in each pixel area, and the refractive index of the sub light guide plate may be greater than the refractive index of an area between adjacent sub light guide plates.

According to the embodiments of the present disclosure, the method of operating the bio sensor may include a step of arranging samples on each of photodetectors arranged in each of the plurality of pixel areas; and a step of irradiating light to a meta lens on the sample. The plurality of pixel areas may include a first pixel area into which light of the first wavelength band is incident; a third pixel area into which light of the third wavelength band is incident; and a second pixel area between the first pixel area and the third pixel area into which light of the second wavelength band is incident, and the difference between the first wavelength band and the second wavelength band, and the difference between the second wavelength band and the third wavelength band may be each greater than the difference between the first wavelength band and the third wavelength band.

The sample may include a sample or a mixture of a sample and a reagent.

The step of arranging the samples on each of the photodetectors arranged in each of the plurality of pixel areas may include a step of adding the sample after placing the reagent.

The method of operating the bio sensor may further include a step of generating a wavelength-specific spectrum based on a pixel signal output from the photodetector, after the step of irradiating light to the meta lens on the sample.

The method of operating the bio sensor may further include a step of determining symptoms or properties of the sample based on the pixel signal output from each of the photodetectors.

According to the embodiments of the present disclosure, the method of operating a bio sensor may include a step of arranging samples on each of photodetectors arranged in each of the plurality of pixel areas; a step of irradiating light to a meta lens on the sample; a step of changing a light path of a light spectrally split through the meta lens by using a light guide plate; and a step of generating a wavelength-specific spectrum based on a pixel signal output from the photodetector.

The plurality of pixel areas may receive different wavelengths along a row direction and the same wavelength along a column direction.

Although a number of illustrative embodiments have been described with reference to the exemplified drawings, it is to be understood that the various modifications or enhancements of the disclosed embodiments and other embodiments can be devised and/or illustrated in this patent document.

1. A bio sensor, comprising:
a meta lens configured to receive light from outside and spectrally split the light into different wavelength bands including a first wavelength band, a second wavelength band, and a third wavelength band; and
a plurality of pixel areas configured to receive the light that has reacted with a sample,
wherein the plurality of pixel areas comprises:
a first pixel area including a first photodetector configured to receive light of the first wavelength band;
a third pixel area including a second photodetector configured to receive light of the third wavelength band; and
a second pixel area disposed between the first pixel area and the third pixel area and including a third photodetector configured to receive light of the second wavelength band, and
wherein each of a difference between the first wavelength band and the second wavelength band, and a difference between the second wavelength band and the third wavelength band is greater than a difference between the first wavelength band and the third wavelength band.

2. The bio sensor of claim 1, wherein the meta lens is configured to split the light from outside into hyperspectral wavelength bands.

3. The bio sensor of claim 1, further comprising:
a sample storage area disposed between the meta lens and the plurality of pixel areas and including a groove recessed from an upper surface of the sample storage area for holding the sample to be measured; and
a planarizing layer disposed over the sample storage area; and
a sample passage penetrating the planarizing layer.

4. The bio sensor of claim 1, wherein the meta lens comprises meta-structure layers,
each of the meta-structure layers comprising a first portion and a second portion having a lower refractive index than a refractive index of the first portion, and in each of the meta-structure layers, the first portion and the second portion are arranged alternately.

5. The bio sensor of claim 4, wherein the first portion includes silicon nitride, tantalum oxide, or titanium oxide, and the second portion includes silicon oxide or air.

6. The bio sensor of claim 4, wherein the meta lens further comprises an insulating layer between adjacent meta-structure layers, and having a refractive index that is between the refractive index of the first portion and the refractive index of the second portion.

7. The bio sensor of claim 1, wherein the sample is configured to react with the light split from the meta lens.

8. The bio sensor of claim 7, wherein the sample comprises a sample material and a reagent that reacts with the sample material, and the sample reacts with the split lights.

9. The bio sensor of claim 1, wherein a sample over the first pixel area, a sample over the second pixel area, and a sample over the third pixel area are all same.

10. The bio sensor of claim 1, wherein a sample over the first pixel area, a sample over the second pixel area, and a sample over the third pixel area are all different.

11. The bio sensor of claim 1, further comprising: a light guide plate placed in an light path of the light between the meta lens and configured to change a light path of the light and direct the light to be incident into the sample.

12. The bio sensor of claim 11, wherein the light guide plate has a scattering pattern formed on an upper surface of the light guide plate.

13. The bio sensor of claim 11, wherein the light guide plate comprises sub-light guide plates arranged in each pixel area, each sub-light guide plate having a refractive index greater than a refractive index of an area between adjacent ones of the sub-light guide plates.

14. A method of operating a bio sensor, comprising:
using a meta lens spectrally split light received from an outside to light beams in different wavelength bands including a first wavelength band, a second wavelength band, and a third wavelength band;
directing the light beams split by the meta lens to samples to be measured; and
using a plurality of pixel areas to capture light from the samples under illumination of the light beams split by the meta lens,
wherein the plurality of pixel areas comprises:
a first pixel area including a first photodetector configured to receive light of the first wavelength band;
a third pixel area including a second photodetector configured to receive light of the third wavelength band; and
a second pixel area disposed between the first pixel area and the third pixel area and including a third photodetector configured to receive light of the second wavelength band, and
wherein each of a difference between the first wavelength band and the second wavelength band, and a difference between the second wavelength band and the third wavelength band is greater than a difference between the first wavelength band and the third wavelength band.

15. The method of operating the bio sensor of claim 14, wherein the samples comprise a specimen or a mixture of the specimen and a reagent.

16. The method of operating the bio sensor of claim 15, wherein in disposing the samples, placing a reagent and adding the specimen after the placing of the reagent.

17. The method of operating the bio sensor of claim 14, further comprising:
generating a wavelength-specific spectrum based on pixel signals output from the first photodetector, the second photodetector, and the third photodetector, after irradiating of the light to the meta lens.

18. The method of operating the bio sensor of claim 14, further comprising:
detecting or determining symptoms or properties of the samples based on pixel signals output from the first photodetector, the second photodetector, and the third photodetector.

19. A method of operating a bio sensor, comprising:
disposing samples over photodetectors arranged in each of a plurality of pixel areas, each of the photodetectors configured to generate a pixel signal in response to light incident on the plurality of pixel areas;
irradiating light to a meta lens disposed over the samples and configured to spectrally split light incident on the meta lens;
changing a light path of the light spectrally split through the meta lens; and
generating a wavelength-specific spectrum based on pixel signals output from the each of the photodetectors.

20. The method of operating the bio sensor of claim 19, wherein the plurality of pixel areas includes pixel areas that are arranged along a row direction and configured to receive light in different wavelength bands and pixels areas that are arranged along a column direction and configured to receive light with a same wavelength band.
